(19) United States
(12) Patent Application Publication
(10) Pub. No.: US 2024/0232775 A9
(43) Pub. Date: Jul. 11, 2024

(54) FACILITATING EXPERIENCE-BASED MODIFICATIONS TO INTERFACE ELEMENTS IN ONLINE ENVIRONMENTS BY EVALUATING ONLINE INTERACTIONS

(71) Applicant: Adobe Inc., San Jose, CA (US)

(72) Inventors: Atanu R. Sinha, Bangalore (IN); Shiv Kumar Saini, Bangalore (IN); Prithvi Bhutani, Seattle, WA (US); Nikhil Sheoran, Chandigarh (IN); Kevin Cobourn, Austin, TX (US); Jeff D. Chasin, Issaguah, WA (US); Fan Du, Milpitas, CA (US); Eric Matisoff, Glen Ridge, NJ (US)

(21) Appl. No.: 17/969,643

(22) Filed: Oct. 19, 2022

(51) Int. Cl. G06Q 10/0639; G06F 3/0484

(52) U.S. Cl. CPC G06Q 10/06393; G06F 3/0484

(57) ABSTRACT

In some examples, an environment evaluation system accesses interaction data recording interactions by users with an online platform hosted by a host system and computes, based on the interaction data, interface experience metrics. The interface experience metrics includes an individual experience metric for each user and a transition experience metric for each transition in the interactions by the users with the online platform. The environment evaluation system identifies a user with the individual experience metric below a pre-determined threshold, identifies a transition performed by the user that has a transition experience metric below a second threshold, and analyzes the transition to determine users who have performed the transition. The environment evaluation system updates the host system with the individual experience metrics and the transition metrics, based on which the host system can perform modifications of interface elements of the online platform to improve the experience.

### TECHNICAL FIELD

This disclosure relates generally to facilitating modifications to interface elements in online environments based on evaluating the performance of these environments. More specifically, but not by way of limitation, this disclosure relates to evaluating the performance of an online environment by assessing user experience based on user interactions with the online environment to facilitate modifications to interface elements in the online environment.

### BACKGROUND

Online interactive computing environments (also referred to as “online environment”), such as web-based applications or other online software platforms, allow users to perform various computer-implemented functions through graphical interfaces. For instance, an online interactive computing environment can provide functionalities such as allowing users to complete transactions in the computing environment, or post content, such as texts, images, or videos, to graphical interfaces provided by the computing environment. To measure the performance of the online interactive computing environment, metrics such as the number of visits, the number of unique visitors, and the time spent by visitors in the computing environment are typically used. However, these traditional metrics do not provide information about the browsing experiences of the users. Nor do they identify the specific state transitions in the online environment that cause friction in browsing. As a result, these metrics lead to an inaccurate and incomplete measurement of the performance of the online interactive computing environment.

### SUMMARY

Certain embodiments involve evaluating interaction sessions of users with an online interactive computing environment to identify individual user experiences and individual state transition performances, and, in some cases, performing modifications to the evaluated interactive computing environment. In one example, an environment evaluation system is included in or communicatively coupled to a host system that hosts an online platform with which user devices interact. The environment evaluation system accesses interaction data generated by interactions between the one or more user devices and the online platform. The environment evaluation system computes interface experience metrics for the users based on the interaction data. The interface experience metrics includes an individual experience metric for each user and a transition experience metric for each state transition (a pair of successive actions such as a pair of successive web page visits) in the interactions by the users. Based on the individual experience metrics and the transition experience metrics, the environment evaluation system identifies the users having poor experiences (e.g., having individual experience metrics below a threshold) and frictional transitions that cause the poor experiences. The environment evaluation system further transmits the interface experience metrics to the host system, which can cause content of the interface elements of the online platform to be modified based on the interface experience metrics.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment for evaluating the performance of an online environment by assessing user experience based on user interactions and facilitating modifications to interface elements in the online environment, according to certain aspects of the present disclosure.

FIG. 2 depicts an example of a process for facilitating the modification to interface elements in an online environment based on interface experience metrics, according to certain aspects of the present disclosure.

FIG. 3 depicts an example of the distribution of individual experience metrics of the users of an online environment, according to certain aspects of the present disclosure.

FIG. 4 depicts an example of transitions that users of the online environment have made and the associated transition experience metrics, according to certain aspects of the present disclosure.

FIG. 5 depicts an example of segment analysis for users who have performed a specific transition, according to certain aspects of the present disclosure.

FIG. 6 depicts an example of in-session experience assessment for a user visiting an online environment, according to certain aspects of the present disclosure.

FIG. 7 depicts an example of a computing system for implementing certain aspects of the present disclosure.

### DETAILED DESCRIPTION

Certain embodiments involve evaluating interaction sessions of users with an online interactive computing environment to identify individual user experiences and individual state transition performances, and, in some cases, performing modifications to the evaluated interactive computing environment. For instance, an environment evaluation system accesses interaction data generated by interactions between user devices and the online interactive computing environment. The environment evaluation system computes interface experience metrics for the users based on the interaction data. Based on the interface experience metrics, the environment evaluation system identifies the users having poor experiences and frictional transitions causing the poor experiences. The environment evaluation system further transmits the interface experience metrics to a host system of the online interactive computing environment, which can cause content of the interface elements of the online interactive computing environment to be modified.

The following non-limiting example is provided to introduce certain embodiments. In this example, an environment evaluation system, which is included in or in communication with a host system hosting an online platform configured to provide an online environment, executes an experience metric evaluation module. The experience metric evaluation module allows for enhancing interactive user experiences with the online environment. To do so, the environment evaluation system accesses interaction data from the online platform, where the interaction data is generated by interactions that occur when user devices use one or more interfaces of the online environment provided by the online platform.

Continuing with this example, the environment evaluation system determines interface experience metrics for the individual users and individual transitions based on the interaction data. For example, the interface experience metrics includes an individual experience metric for each user to measure individual users' experience with the online environment. The interface experience metrics further include a transition experience metric for each state transition (a pair of successive actions such as a pair of successive web page visits) in the interactions by the users to measure the experience of the users with respect to the transition. In some examples, the individual experience metric and the transition experience metric are calculated based on proxy ratings (e.g., model computed values from clickstream data of the users in the interaction data that proxy for ratings).

Based on the determined interface experience metrics, the environment evaluation system identifies users who have poor experience with the online environment, such as users whose individual experience metrics are below an individual experience metric threshold. Likewise, the environment evaluation system also identifies frictional transitions in the online environment with which the users have poor experiences, such as the transitions with transition experience metrics below a transition experience metric threshold. The environment evaluation system further transmits or otherwise provides the interface experience metrics, and in some cases, the identified frictional transitions, to one or more computing systems of the host system that are used to host or configure the online platform.

In some examples, providing the interface experience metric to systems that host online platforms can allow various interface elements of the interactive computing environment to be modified to enhance the experience of the users, to be customized to particular users, or some combination thereof. In one example, poor user experience may be detected during a session of a user visiting the online environment. Upon detecting the poor user experience (e.g., the individual experience metric is below the individual experience metric threshold), additional interface elements may be presented in the online environment to facilitate the user's visit. The additional interface elements may be a tool configured to activate a virtual agent to assist the visit, or an interface element presenting additional information related to the page that the user is visiting. In other examples, the host system may also revise the content of the interface elements on the page that the user is visiting to provide a better presentation and transmit the revised content to the user.

As described herein, certain embodiments provide improvements to interactive computing environments by solving problems that are specific to online platforms. These improvements include more effectively configuring the functionality of an interactive computing environment based on accurate and precise evaluations of user experience within the interactive computing environment. Facilitating these experienced-based modifications involves identifying problematic or beneficial states of an interactive computing environment, which is particularly difficult in that the states of an interactive computing environment involve instantaneous transitions between different types of states (e.g., states corresponding to a combination of different content layouts, interface elements, etc.) that are traversed during a journey through the environment, where any given state may not last long from the perspective of the user. Thus, evaluating an experience within an interactive computing environment is uniquely difficult because these ephemeral, rapidly transitioning states could significantly impact a user's online experience even though any given state may not be memorable enough for a user to recall or evaluate after the fact (e.g., via a survey).

Because these state-evaluation problems are specific to computing environments, embodiments described herein utilize automated techniques that are uniquely suited for assessing computing environments. For instance, a computing system automatically applies various rules of a particular type (e.g., rules to calculate metrics, rules utilized to identify poor experience and frictional transitions) to interaction data and thereby computes objective measurements of online experience, sometimes in a real-time manner. The measurements are objective at least because a computing system applies these rules in an automated manner, rather than relying on subject memories and judgments. The objective measurements are usable for enhancing a computing environment by, for example, modifying interface elements or other aspects of the environment. Using one or more techniques described herein can therefore allow for a more accurate and precise evaluation of which transitions of an interactive environment are more likely to help or hinder an intended outcome of using the online platform. Consequently, certain embodiments more effectively facilitate modifications to a computing environment that facilitate desired functionality, as compared to existing systems.

As used herein, the term “online platform” is used to refer to software program, which when executed, provides an online interactive computing environment that includes various interface elements with which user devices interact. For example, clicking or otherwise interacting with one or more interface elements during a session causes the online platform to manipulate electronic content, query electronic content, or otherwise interact with electronic content that is accessible via the online platform. In this disclosure, the term “online platform” may also be used to refer to the interactive computing environment that it provides.

As used herein, the term “interface element” is used to refer to a user interface element in a graphical user interface that presents content or performs, in response to an interaction from a user device, one or more operations that change a state of an interactive computing environment. Examples of changing the state of an interactive computing environment include presenting additional contents, activating a tool to invoke additional functions, selecting a function from a menu interface element, entering query terms in a field interface element used for searching content, etc.

As used herein, the term “interaction data” is used to refer to data that are generated by one or more user devices interacting with an online platform and describes how the user devices interact with the online platform. An example of interaction data is clickstream data. Clickstream data can include one or more data strings that describe or otherwise indicate data describing which interface features of an online service were “clicked” or otherwise accessed during a session. Examples of clickstream data include any user interactions on a website, user interactions within a local software program of a computing device, information from generating a user profile on a website or within a local software program, or any other user activity performed in a traceable manner. Another example of interaction data includes system-to-system interactions between a user device and server hosting an online platform (e.g., data describing transmission of network addresses, establishing communications, API calls, etc.).

As used herein, the term “state transition” is used to refer to a pair of successive actions performed by a user in an online platform. For example, the state transition can be a pair of successive web page visits by a user. In another example, the state transition can be a pair of successive activations of user interface elements in a web page.

As used herein, the term “interface experience metric” is used to refer to a metric describing or otherwise indicating a quality of an interactive user experience in the online platform. For example, the interface experience metrics can include an individual experience metric for each user to measure individual users' experience with the online environment and a transition experience metric for each state transition in the interactions by the users to measure the experience of the users with respect to the state transition.

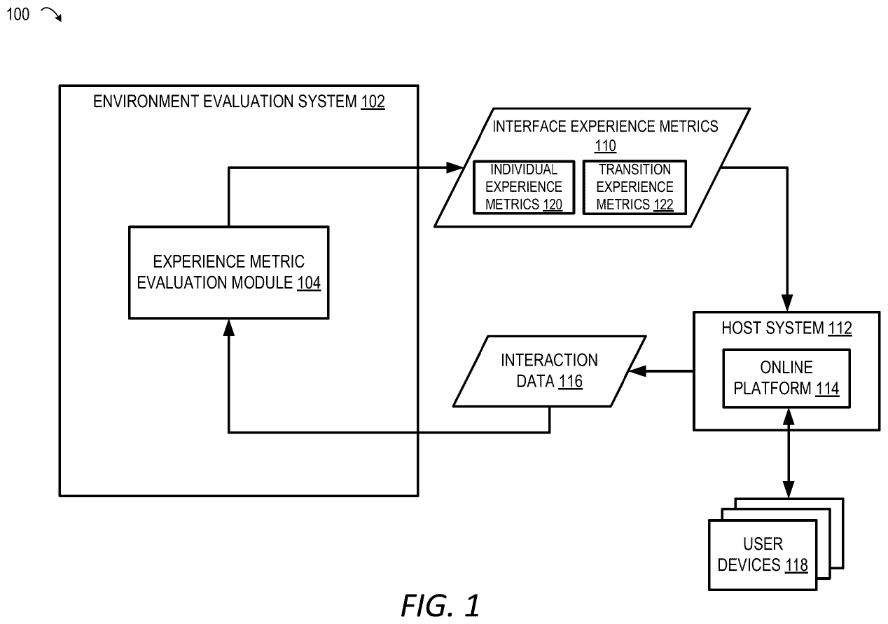

Referring now to the drawings, FIG. 1 depicts an example of computing environment 100 in which an environment evaluation system 102 evaluates and, in some cases, facilitates modifications to an online platform 114 provided by a host system 112. The environment evaluation system 102 determines interface experience metrics 110 based on interaction data 116 generated by interactions between the online platform 114 and user devices 118. The interface experience metrics 110 indicate a quality of the interactive user experience in the online platform 114. Because the environment evaluation system 102 generates the interface experience metrics 110 in an automated manner based on observable interaction data 116 (e.g., clickstream data), the resulting interface experience metrics 110 provide objective measures of the quality of user experience within the online computing environment.

The environment evaluation system 102 provides the interface experience metrics 110 to the host system 112. In some examples, providing the interface experience metrics 110 to the host system 112 causes one or more features of the online platform to be changed such that interactive user experiences are enhanced for various user devices 118.

For example, the environment evaluation system 102 receives interaction data 116 that is generated by one or more user devices 118 interacting with the online platform 114. An example of interaction data 116 is clickstream data. Clickstream data can include one or more data strings that describe or otherwise indicate data describing which interface features of an online service were “clicked” or otherwise accessed during a session. Examples of clickstream data include any user interactions on a website, user interactions within a local software program of a computing device, information from generating a user profile on a website or within a local software program, or any other user activity performed in a traceable manner. Another example of interaction data 116 includes system-to-system interactions between the user device 118 and a host system 112 that may not involve user input (e.g., sending network addresses, establishing communications, API calls, etc.). Another example of interaction data 116 includes a user identifier generated through interactions between the user device 118 and an online platform 114 of the host system 112.

In some examples, the host system 112 could include one or more servers that log user activity in the online platform 114 and transmit, to the environment evaluation system 102, the interaction data 116 describing the logged activity. In additional or alternative examples, a user device 118 could execute one or more services (e.g., a background application) that log user activity in the online platform 114 and transmit, to the environment evaluation system 102, the interaction data 116 describing the logged activity.

In these various examples, logging the user activity includes, for example, creating records that identify a user entity (e.g., the user device 118 or a credential used to access the online platform 114), timestamps for various interactions that occur over one or more sessions with the online platform 114, and event identifiers that characterize the interaction. Examples of event identifiers include an identifier of a particular interface element that was clicked or otherwise used, an identifier of a particular group of interface elements to which an interface element that was clicked or otherwise used belongs, etc.

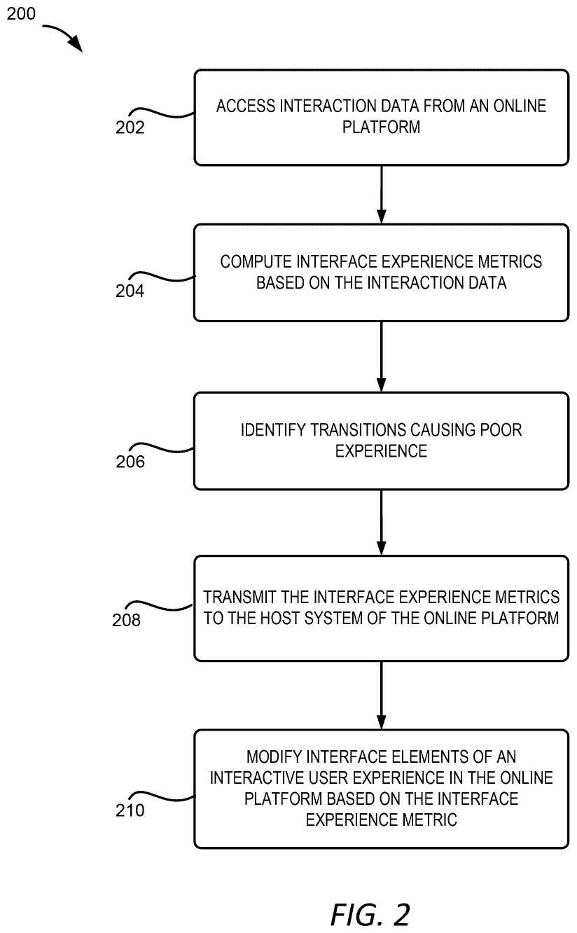

In some examples, the environment evaluation system 102 computes one or more interface experience metrics 110 from the interaction data 116. In some examples, the environment evaluation system 102 computes an individual experience metric 120 for each user to measure individual users' experience with the online environment and a transition experience metric 122 for each state transition (a pair of successive actions such as a pair of successive webpage visits) in the interactions by the users to measure the experience of the users with respect to the state transition. For example, the environment evaluation system 102 computes the individual experience metric 120 for a user as a proportion of pairwise successive actions of a user that show increase in proxy ratings associated with the user. The environment evaluation system 102 computes the transition experience metric for a pair of successive actions as a proportion of instances of the pair of successive actions that show increase in proxy ratings associated with the user. Additional details regarding calculating interface experience metrics 110 are provided with respect to FIG. 2.

The environment evaluation system 102 may transmit interface experience metrics 110 to the host system 112. In some examples, doing so causes the host system 112 to modify an interactive user experience of the online platform 114 based on the interface experience metrics 110. In one example, a development platform could rearrange the layout of an interface so that features or content associated with higher interface experience metrics 110 are presented more prominently, features or content associated with lower interface experience metrics 110 are presented less prominently, or some combination thereof. In various examples, the development platform performs these modifications automatically based on an analysis of the interface experience metrics 110, manually based on user inputs that occur subsequent to presenting the interface experience metrics 110, or some combination thereof. In another example, the host system 112 modifies the content of the interface elements to better present the information (e.g., using a clear language, a more user-friendly format, etc.) and deliver the modified content to the device associated with the user.

In some examples, modifying one or more interface elements is performed in real time, i.e., during a session between the online platform 114 and a user device 118. In some examples, the interface experience metrics 110 are computed during a session when a user visits the online environment. The environment evaluation system 102 accesses the interaction data as the user interacts with the online platform and computes the individual experience metric 120, the transition experience metric 122, or both. Based on the calculated interface experience metrics 110, the environment evaluation system 102 may determine that the user is having a poor experience with the online environment and thus transmits or otherwise notifies the host system 112 to modify the online platform to improve the experience of the user while he or she is still in session. For example, the host system 112 may introduce additional interface elements into the online environment to facilitate the user's visit, such as adding a tool that is configured to activate a virtual agent to assist the visit, or adding an interface element presenting additional information related to the page that the user is visiting. The environment evaluation system 102 can continue to evaluate the online experience during the session and thereby determine if additional changes to the interactive computing environment are warranted.

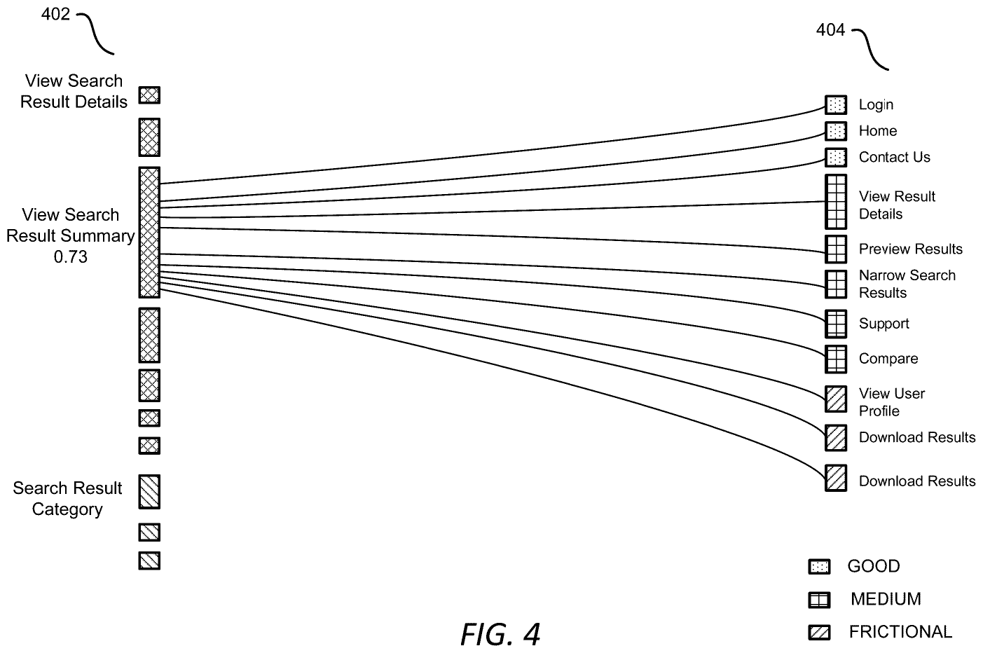

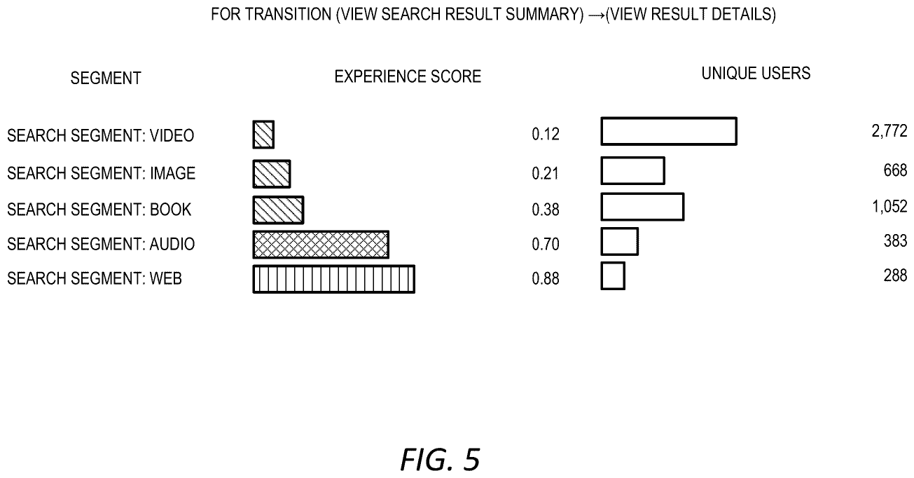

In other examples, the interactive computing environment is modified after the sessions are complete and the interface experience metrics 110 computed for the sessions are transmitted to the host system 112. Based on the interface experience metrics 110, the host system 112, the environment evaluation system 102, or another system identifies users having poor experiences with the online environment and determines the causes of the poor experiences. For instance, a user with poor experience can be identified based on the individual experience metric 120 being lower than an individual experience metric threshold, such as 50% of the maximum value of the individual experience metric. For those identified users, frictional transitions (e.g., a pair of successive actions) taken by the user at the online environment that led to the poor experience are identified. For example, those transitions associated with a transition experience metric 122 lower than a transition experience metric threshold (such as 60% of the maximum value of a transition experience metric) can be identified as frictional transitions. Based on the identified frictional transitions, the host system 112 can determine which part of the online environment should be modified to improve the experience. For example, if a transition from a search result page to a detailed result page is identified as causing poor experience, the host system 112 may determine that the interface elements associated with these two pages should be modified. To further improve the interface experience metrics, the host system 112, the environment evaluation system 102, or another system identifies users who have performed the transitions. Modified content of the interface elements may be transmitted to the user devices associated with these users to improve the experience of these specific users. Additional details regarding identifying frictional transitions are provided with respect to FIGS. 4-5.

One or more computing devices are used to implement the environment evaluation system 102 and the host system 112. For instance, the environment evaluation system 102, the host system 112, or both could include a single computing device, a group of servers or other computing devices arranged in a distributed computing architecture, etc. The online platform 114 can be any suitable online service for interactions with the user device 118. Examples of an online platform include a content creation service, an electronic service for entering into transactions (e.g., searching for and purchasing products for sale), a query system, a searching system, etc. In some examples, one or more host systems 112 are third-party systems that operate independently of the environment evaluation system 102 (e.g., being operated by different entities, accessible via different network domains, etc.). In additional or alternative examples, one or more host systems 112 include an environment evaluation system 102 as part of a common computing system. The user device 140 may be any device which is capable of accessing an online service. For non-limiting examples, user device 140 may be a smart phone, smart wearable, laptop computer, desktop computer, or other type of user device.

FIG. 2 depicts an example of a process 200 for facilitating the modification of an interactive user experience based on one or more interface experience metrics, according to certain aspects of the present disclosure. One or more computing devices (e.g., the computing environment 100) implement operations depicted in FIG. 2 by executing suitable program code. For illustrative purposes, the process 200 is described with reference to certain examples depicted in the figures. Other implementations, however, are possible.

At block 202, the process 200 involves accessing interaction data from an online platform. For instance, interactions between a user device 118 and an online platform 114 may create interaction data 116. The environment evaluation system 102 accesses interaction data 116 from a suitable non-transitory computer-readable medium or other memory device. In some examples, interaction data 116 is stored on one or more non-transitory computer-readable media within host system 112. The environment evaluation system 102 accesses the interaction data 116 via suitable communications with a host system 112 (e.g., a push or batch transmission from the host system 112, a pull operation from the environment evaluation system 102, etc.). In additional or alternative examples, the environment evaluation system 102 and the host system 112 are communicatively coupled to a common data store (e.g., a set of non-transitory computer-readable media, a storage area network, etc.). The environment evaluation system 102 retrieves the interaction data 116 from the data store after the host system 112 stores the interaction data 116 in the data store. In additional or alternative examples, interaction data 116 is stored at user devices 118 and transmitted to the environment evaluation system 102 directly, without involving the host system 112. For instance, a background application on each user device 118 could transmit a set of interaction data 116 for that user device 118 to the environment evaluation system 102.

At block 204, the process 200 involves computing interface experience metrics based on the interaction data 116. In some examples, the environment evaluation system 102 computes an individual experience metric 120 for each user to measure individual users' experience with the online environment and further computes a transition experience metric 122 for each state transition (a pair of successive actions such as a pair of successive webpage visits) in the interactions by the users to measure the experience of the users with respect to the state transition.

In some examples, the individual experience metric 120 and the transition experience metric 122 are calculated as follows. Define the k-th user's observed journey as j^{(k)}=[A₁, A₂, . . . , Aₘ] and her proxy rating for action Aₜ as y_{A}_{ₜ}^{(k)}. m may vary across users. The proxy rating can be developed from the clickstream data of the user in the interaction data 116. The decision orientation of the user (where to visit in a subsequent step or session given the current state) can be modeled based on reinforcement learning (RL). In the RL, given a goal and a reward function, the value function of the RL model generates a value of being in a state, for every state, and for every user. The value is interpreted as a proxy rating for each click action, and the proxy ratings are used to identify the click actions that increase or decrease ratings as related to enhancing or hindering the overall user experience. The change of proxy ratings going from one action to the next is used as an indicator of actual ratings.

A binary classifier for proxy ratings can be defined as follows. Given actions A_{t-q} and Aₜ, lag(q) is a change in proxy ratings from A_{t-q} to Aₜ. An increase in proxy ratings is assumed positive, assigned a value 1, and a decrease is assumed negative and assigned a 0. For k-th customer, lag(q) is defined as:

$${z}_{{A}_{t - q} , {A}_{t}}^{( k )} = \{ \begin{matrix}1 , & if {y}_{{A}_{t}}^{( k )} - {y}_{{A}_{t - q}}^{( k )} > 0 ; \\ 0 , & otherwise .\end{matrix} \qquad ( 1 )$$

The interface experience metric 110 can be defined as proportion of all pairwise, successive actions (that is, q=1) that show an increase in proxy rating values. This metric intuitively captures the notion of how often actions lead to better ratings. This metric is defined in two ways or includes two metrics, the individual experience metric Z^{(k)} and the transition experience metric Z(aᵤ, a_{w}). The individual experience metric Z^{(k)} is defined for each user over his or her journey and renders the proportion of her pairwise successive actions that show increase in proxy ratings. For the k-th customer,

$${Z}^{( k )} = \frac{1}{\vert {J}^{( k )} \vert - 1} {\sum }_{t = 1}^{\vert {J}^{( k )} \vert - 1} {z}_{{A}_{t - 1} , {A}_{t}}^{( k )} \qquad ( 2 )$$

For a customer performing a sequence of 20 click actions, there are 19 pairwise successive actions. If, for example, 11 pairs show an increase in proxy ratings, the proportion Z^{(k)} is 11/19.

The transition experience metric Z(aᵤ, a_{w}) is defined for every pair of successive actions (aᵤ, a_{w}) and represents the proportion of all instances of a pair of successive actions (q=1) that show an increase in proxy ratings.

$$Z ( {a}_{u} , {a}_{w} ) = \frac{1}{N ( {a}_{u} , {a}_{w} )} {\sum }_{k = 1}^{K} {\sum }_{t = 1}^{\vert {J}^{( k )} \vert - 1} {z}_{{A}_{t - 1} , {A}_{t}}^{( k )} \qquad ( 3 )$$

for those t where Aₜ₋₁=aᵤ and Aₜ=a_{w} and N(aᵤ, a_{w}) denotes the number of instances of successive action-pair (aᵤ, a_{w}) in the data. If a pair of successive actions occurs in 1000 instances with 350 of them showing increase in proxy ratings, the proportion Z(aᵤ, a_{w}) is 350/1000. A user can traverse the (aᵤ, a_{w}) pair multiple times in a session, where each pair is a single instance. As such, this use can contribute multiple instances to compute Z(aᵤ, a_{w}). For example, if (aᵤ, a_{w})=(list of search results, result detail), it is natural for a user to go back and forth between these two pages at different points across the length of a session. As such, the transition experience metric preserves this natural phenomenon while computing Z(aᵤ, a_{w}). The calculated transition experience metric 122 thus provides more accurate computation than using a single average value for this user across all instances which loses information on variability across instances within a user. Functions included in block 204 can be used to implement a step for computing interface experience metrics for the plurality of users based on the interaction data.

At block 206, the process 200 involves identifying the frictional transitions that lead to poor experience based on the interface experience metrics 110. For example, the individual experience metric 120 is analyzed to identify the users having low individual experience metrics 120 (e.g., lower than the individual experience metric threshold). The transitions that were made by these users are identified and the associated transition experience metrics 122 are retrieved. Among the transitions taken by these users, the transitions that have a low transition experience metric 122 (e.g., lower than the transition experience metric threshold) are identified as the frictional transitions that cause the poor experience of the users. Modifications to the online platform 114 can be focused on these frictional transitions and users who have made the frictional transitions.

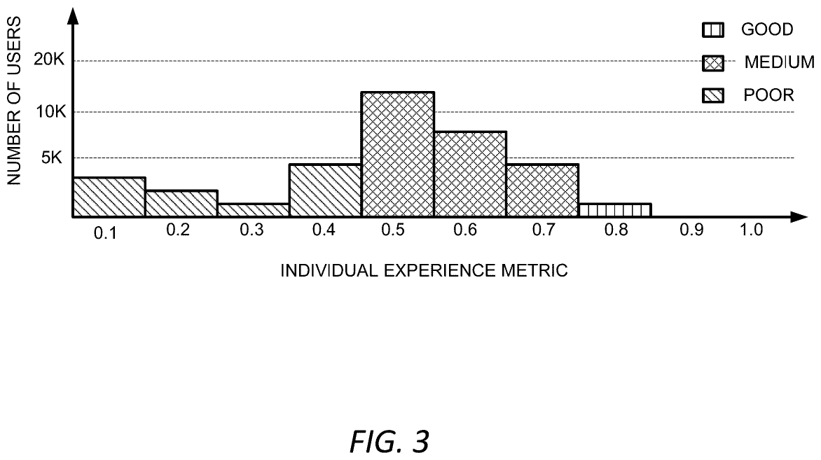

FIG. 3 depicts an example of the distribution of individual experience metrics 120 of the users of an online platform, according to certain aspects of the present disclosure. The individual experience metrics 120 shown in FIG. 3 are calculated according to Eqn. (2) and is within the range of 0 and 1. These individual experience metrics 120 are calculated based on interaction data collected on Jul. 1, 2022, to Jul. 3, 2022, over 35,440 users. The users are categorized into three classes: users with good experience (the individual experience metric 120 is higher than 0.7), users with medium experience (the individual experience metric 120 is between 0.5 and 0.7), and users with poor experience (the individual experience metric 120 is lower than 0.5). As shown in FIG. 3, only a few users have good experience; many users have medium experience and a sizable number of users have poor experience. The thresholds for determining good, medium and poor experiences can be selected as other values. Further, the three-class categorization is for illustration only and any number of classes can be used to categorize users depending on the use cases.

The transitions made by the users having a poor experience can be analyzed to identify the frictional transitions. FIG. 4 shows an example of transitions that users with a poor experience identified in FIG. 3 have experienced and the associated transition experience metrics, according to certain aspects of the present disclosure. In the example of FIG. 4, the transition is from a source web page to a destination web page. The left portion of FIG. 4 shows a list 402 of web pages before the transition (source web pages). The right portion shows a list of pages (destination web pages) after a transition from the “View Search Result Summary” source web page. Each of the web pages shown in the list 402 is associated with an experience metric which is calculated by combining the individual experience metric 120 of users who made the transitions from the web page. For example, the experience metric for the “View Search Result Summary” page is 0.73 which is calculated by averaging the individual experience metrics 120 of the users who have made a transition from this page. Other ways to generate the experience metric for a page or an action can be similarly defined. In the example shown in FIG. 4, the pages in the list 402 are ordered according to the values of the experience metrics of the pages.

FIG. 4 shows the transitions made from the “View Search Result Summary” page to a list 404 of other pages, such as “View Result Details” page, “Preview Results” page, and so on. Each of the transitions is associated with a transition experience metric 122 as calculated according to Eqn. (3). According to transition experience metrics 122, these transitions can be categorized into three categories: “Good,” “Medium,” and “Frictional.” Similar to the individual experience metrics 120 shown in FIG. 3, good transition can be defined as transitions having a transition experience metric 122 higher than 0.7; medium transition can be defined as transitions having a transition experience metric 122 between 0.5 and 0.7; and frictional transitions can be defined as transitions having a transition experience metric 122 below 0.5. The categories of the respective transitions are shown along with the destination pages in FIG. 4. Based on the categories, the frictional transitions and the associated source pages and destination pages can be identified for improvement.

For a given frictional transition, users who have taken this frictional transition can be identified. The number of these users can be used to indicate the impact of the frictional transition thereby measuring the severity of the friction. The severity of the friction associated with frictional transitions can be used to prioritize the modifications of the interface elements involved in the transitions. For example, a frictional transition that impacted a large number of users should be addressed before another frictional transition that impacted a small number of users. In other examples, the severity of the friction is defined based on the importance of the transition. A transition identified as an important transition is given a higher priority than a less important transition even if the high-priority transition impacts a smaller number of users. In addition, each frictional transition can be further analyzed to determine the contributing segments. In the above example, the transition from “View Search Result Summary” page to the “View Result Details” page may be associated with different segments, such as image search, video search, book search, news search, and so on. For each of the segments, an experience score and the population can be determined.

FIG. 5 shows an example of segment analysis for users who have performed a specific transition, according to certain aspects of the present disclosure. In FIG. 5, the segment analysis is performed for the transition from the “View Search Result Summary” page to the “View Result Details” page. For each segment, an experience score by averaging the individual experience metrics 120 of the users who are in the segment is calculated and the population of the segment is also determined. Based on the analysis shown in FIG. 5, the segment “Video Search” is the main cause of the friction where a large number of users having a low individual experience metric 120. As such, modifications or other improvements can be focused on the interface elements related to this segment. In addition, users in a segment that has a low experience score may be contacted, such as through email or other ways, to provide improved content of the interface elements. For instance, an improved search result summary page for video search may be delivered to the users in this segment so that the users can find the desired results easily. In another example, the segment analysis further includes analyzing the scores of individual users over time to determine whether each user's experiences are diminishing and is a risk of exiting the online platform. Functions included in block 206 can be used to implement a step for identifying, from the plurality of users, a set of users who have a poor experience with the online platform.

Referring back to FIG. 2, at block 208, the process 200 involves transmitting the interface experience metric to the content provider service. For instance, the interface experience metric computed at block 204 may be transmitted to host system 112 via a local area network, a wide area network, or some combination thereof. At block 210, the process 200 involves modifying interface elements of an interactive user experience in an online platform based on interface experience metrics. For instance, a host system 112 includes one or more computing devices that can modify interface elements of online platform 114 based on received interface experience metrics 110. In one example, an interface element may include, but is not limited to, visual content, such as colors and layout, available click actions in certain click states, and design features, such as menus, search functions, and other elements. In some aspects, the interface elements may be modified in a particular manner when lower interface experience metrics 110 are received. In other aspects, the interface elements may be modified in a different particular manner when higher interface experience metrics 110 are received. The interface elements may be modified in any suitable manner including, but not limited to, the examples discussed above with respect to FIG. 1.

The examples shown in FIGS. 3-5 are for illustration only and should not be construed as limiting. The operations in block 206 can be performed by the environment evaluation system 102, the host system 112 after the interface experience metrics 110 are transmitted to the host system 112, or another system. In addition, user interfaces such as those shown in FIGS. 3-5 can be generated and presented to illustrate or facilitate the identification of frictional transitions, users experiencing the frictional transitions, users with poor experiences, and so on. While FIG. 4 shows a page-to-page transition, the transitions can include other types of transition from one state to another state. For example, the transitions can occur within the same webpage by expanding, invoking or otherwise activating interface elements on the webpage.

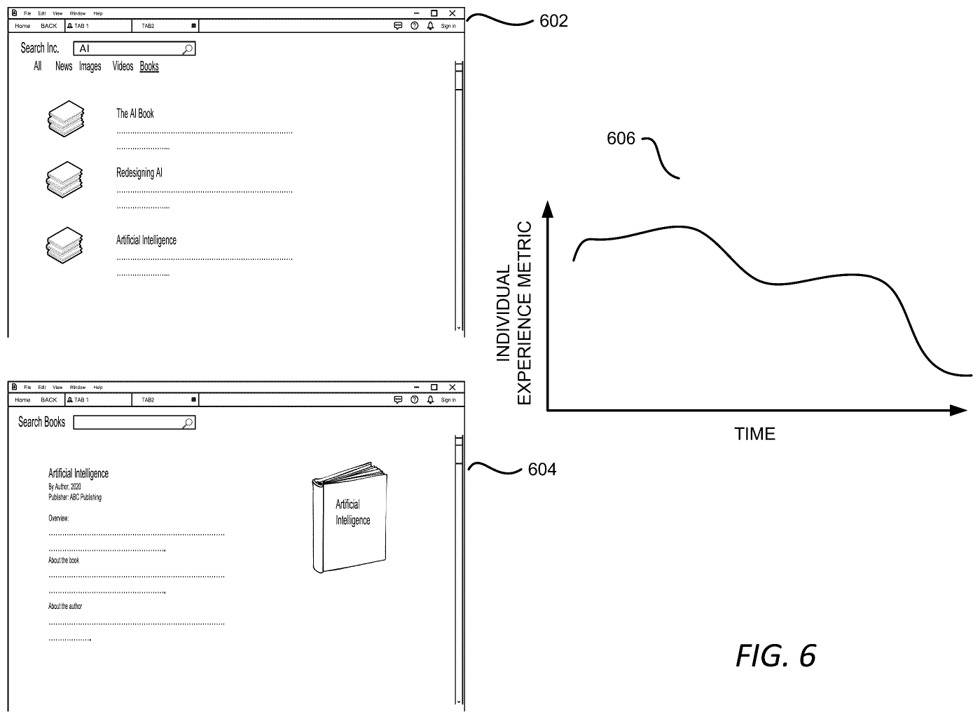

FIG. 6 depicts an example of in-session experience assessment for a user visiting an online environment, according to certain aspects of the present disclosure. FIG. 6 shows webpages 602 and 604, and an in-session experience assessment diagram 606. The webpage 602 is a search result page presented to a user via in a user interface of the online platform 114. When the user clicks on one search result item, webpage 604 is shown in the user interface to display the details about the selected result item. As the user interacts with the user interface during the current session, a sequence of values for the individual experience metric 120 of the user is calculated. For example, the value of the individual experience metric of the user is calculated each time the user performs an action, such as clicking on a link, clicking on a button. Alternatively, or additionally, the value of the individual experience metric of the user can be calculated for every on actions performed by the user, with n being a natural number, such as 2, 3 . . . . The value of the individual experience metric of the user can also be calculated based on time, such as every 2 seconds. In some examples, temporal difference (TD) learning is used to calculate the individual experience metric values in real time or near real time.

Diagram 606 shows the sequence of the values of the individual experience metric 120. The sequence of individual experience metric values can be analyzed to determine whether the user is experiencing frictions during the session. For example, the friction can be determined if the sequence of individual experience metric values shows a decreasing trend as shown in FIG. 6. In other examples, the frictions can be detected if there is sudden drop of the metric value (e.g., the decrease of the metric value from a previous value exceeds a certain threshold) or other types of value decreasing. If the user is experiencing frictions during the session, the host system 112 can configure the online platform to modify the interface elements in the user interface to improve the experience. For example, a tool configured to activate a virtual agent can be added to the user interface on the page the user is visiting to offer help to the user. Alternatively, or additionally, a pop-up window with additional information or additional tools related to the content of the page the user is experiencing the friction can be displayed. Other ways to intervene in the session to offer improvements to the experience can be utilized.

In some examples, a dynamic pattern of values for the individual experience metric, such as the pattern of values shown in the diagram 606 of FIG. 6 can be obtained for the actions in each session by each user. The pattern of values can be used for clustering the users. Compared with grouping users based on the average value, the pattern-based clustering recognizes the sequence of the actions and thus provides more accurate clustering. If certain patterns emerge as value enhancing, these patterns provide insights about which navigation patterns are satisfying to users, and thus can be turned into recommendations for other users of the online platform to emulate.

While the above description focuses on pairwise state transitions, a longer sequence of state transitions (e.g., a sequence of N consecutive webpage visits) can be analyzed in a similar way. For example, pairwise values can be obtained as discussed above for the sequence of transitions to evaluate the performance of the sequence of transitions. Such an evaluation is useful in designing webpages and determining how the webpages should be rendered. Also, alternative sequences can be created and imputed with pairwise values to estimate the performance of the alternative sequences.

Example of a Computing System for Implementing Certain Aspects

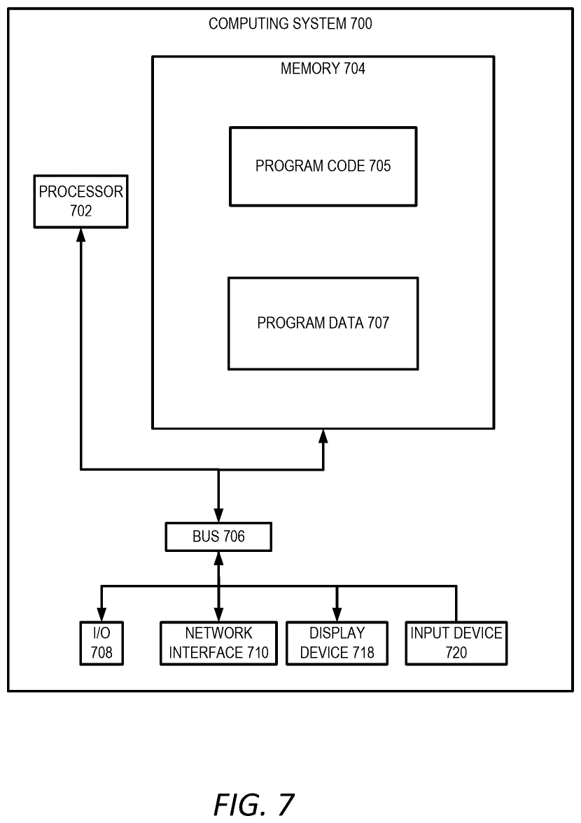

Any suitable computing system or group of computing systems can be used for performing the operations described herein. For example, FIG. 7 depicts an example of the computing system 700. The implementation of computing system 700 could be used for one or more of the environment evaluation system 102 and the host system 112. In other examples, a single computing system 700 having devices similar to those depicted in FIG. 7 (e.g., a processor, a memory, etc.) combines the one or more operations and data stores depicted as separate systems in FIG. 1.

The depicted example of a computing system 700 includes a processor 702 communicatively coupled to one or more memory devices 704. The processor 702 executes computer-executable program code stored in a memory device 704, accesses information stored in the memory device 704, or both. Examples of the processor 702 include a microprocessor, an application-specific integrated circuit (“ASIC”), a field-programmable gate array (“FPGA”), or any other suitable processing device. The processor 702 can include any number of processing devices, including a single processing device.

A memory device 704 includes any suitable non-transitory computer-readable medium for storing program code 705, program data 707, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 700 executes program code 705 that configures the processor 702 to perform one or more of the operations described herein. Examples of the program code 705 include, in various examples, the experience metric evaluation module 104 by the environment evaluation system 102, the online platform 114, or other suitable applications that perform one or more operations described herein (e.g., one or more development applications for configuring the online platforms 114). The program code may be resident in the memory device 704 or any suitable computer-readable medium and may be executed by the processor 702 or any other suitable processor.

In some examples, one or more memory devices 704 stores program data 707 that includes one or more datasets and models described herein. Examples of these datasets include interaction data, performance data, etc. In some examples, one or more of data sets, models, and functions are stored in the same memory device (e.g., one of the memory devices 704). In additional or alternative examples, one or more of the programs, data sets, models, and functions described herein are stored in different memory devices 704 accessible via a data network. One or more buses 706 are also included in the computing system 700. The buses 706 communicatively couples one or more components of a respective one of the computing system 700.

In some examples, the computing system 700 also includes a network interface device 710. The network interface device 710 includes any device or group of devices suitable for establishing a wired or wireless data connection to one or more data networks. Non-limiting examples of the network interface device 710 include an Ethernet network adapter, a modem, and/or the like. The computing system 700 is able to communicate with one or more other computing devices (e.g., a computing device executing the environment evaluation system 102) via a data network using the network interface device 710.

The computing system 700 may also include a number of external or internal devices, an input device 720, a presentation device 718, or other input or output devices. For example, the computing system 700 is shown with one or more input/output (“I/O”) interfaces 708. An I/O interface 708 can receive input from input devices or provide output to output devices. An input device 720 can include any device or group of devices suitable for receiving visual, auditory, or other suitable input that controls or affects the operations of the processor 702. Non-limiting examples of the input device 720 include a touchscreen, a mouse, a keyboard, a microphone, a separate mobile computing device, etc. A presentation device 718 can include any device or group of devices suitable for providing visual, auditory, or other suitable sensory output. Non-limiting examples of the presentation device 718 include a touchscreen, a monitor, a speaker, a separate mobile computing device, etc.

Although FIG. 7 depicts the input device 720 and the presentation device 718 as being local to the computing device that executes the environment evaluation system 102, other implementations are possible. For instance, in some examples, one or more of the input device 720 and the presentation device 718 can include a remote client-computing device that communicates with the computing system 700 via the network interface device 710 using one or more data networks described herein.

General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device.

Examples of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method, comprising:
operating an environment evaluation system for working with a host system that is configured to host an online platform and perform a modification of interface elements of the online platform based on an individual experience metric computed from interaction data; and
performing, with one or more processing devices of the environment evaluation system, operations comprising:
accessing interaction data recording interactions by a plurality of users with the online platform;
computing, based on the interaction data, an individual experience metric for each of the plurality of users;
identifying a user among the plurality of users by comparing the individual experience metric of the user with a pre-determined threshold value and determining that the individual experience metric of the user is below the pre-determined threshold value;
computing a first transition experience metric for a first pair of successive actions in a sequence of actions in the interactions by the user with the online platform;
computing a second transition experience metric for a second pair of successive actions in the sequence of actions in the interactions by the user with the online platform;
identifying, from at least the first pair of successive actions and the second pair of successive actions, a pair of successive actions performed by the user that has a transition experience metric below a second threshold value;
determining, among the plurality of users, users who have performed the pair of successive actions; and
updating the host system with the individual experience metrics and transition experience metrics comprising the first transition experience metric and the second transition experience metric for use by the host system to perform the modification of the interface elements to improve the individual experience metrics and the transition experience metrics, performing the modification comprising transmitting modified content of the interface elements of the online platform to user devices associated with the users to improve at least one of the individual experience metrics or the transition experience metrics.

2. The method of claim 1, wherein:
accessing the interaction data comprises accessing the interaction data of a user during a session of the user browsing the online platform;
computing the individual experience metric for the user comprises computing a plurality of individual experience metric instances during the session; and
performing the modification of the interface elements comprises modifying the interface elements to include an interface element configured to activate a virtual agent to intervene the session based on determining that the user experiences a friction in the session according to the plurality of individual experience metric instances.

3. The method of claim 2, wherein determining that the user has a poor experience in the session according to the plurality of individual experience metric instances comprises determining that the plurality of individual experience metric instances has a decreasing trend.

4. The method of claim 2, wherein each of the plurality of individual experience metric instances is calculated each time when the user interacts with the online platform.

5. The method of claim 1, wherein computing the individual experience metric for a user comprises computing a proportion of pairwise successive actions of a user that show increase in proxy ratings associated with the user.

6. The method of claim 1, wherein computing the first transition experience metric for the first pair of successive actions comprises computing a proportion of instances of the first pair of successive actions that show increase in proxy ratings associated with the users.

7. The method of claim 1, wherein accessing the interaction data comprises accessing the interaction data of the plurality of users after sessions of the plurality of users browsing the online platform have completed, and wherein the operations further comprise:
clustering the plurality of users based on a pattern of the individual experience metrics associated with respective users; and
presenting the individual experience metrics and the transition experience metrics based on clustering of the plurality of users.

8. A system comprising:
a host system configured to:
host an online platform, and
modify interface elements of the online platform based on individual experience metrics and transition experience metrics computed from interaction data generated by interactions by a plurality of users with the interface elements of the online platform; and
an environment evaluation system comprising one or more processing devices configured for performing operations comprising:
accessing the interaction data;
computing, based on the interaction data, an individual experience metric for each of the plurality of users;
identifying a user among the plurality of users by comparing the individual experience metric of the user with a pre-determined threshold value and determining that the individual experience metric of the user is below the pre-determined threshold value;
computing a first transition experience metric for a first pair of successive actions in a sequence of actions in the interactions by the user with the online platform;
computing a second transition experience metric for a second pair of successive actions in the sequence of actions in the interactions by the user with the online platform;
identifying, from at least the first pair of successive actions and the second pair of successive actions, a pair of successive actions performed by the user that has a transition experience metric below a second threshold value;
determining, among the plurality of users, users who have performed the pair of successive actions; and
transmitting the individual experience metrics and the transition experience metrics comprising the first transition experience metric and the second transition experience metric to the host system, wherein the individual experience metrics and the transition experience metrics cause the host system to transmit modified content of the interface elements of the online platform to the users to improve at least one of the individual experience metrics or the transition experience metrics of the users.

9. The system of claim 8, wherein:
accessing the interaction data comprises accessing the interaction data of a user during a session of the user browsing the online platform;
computing the individual experience metric for the user comprises computing a plurality of individual experience metric instances during the session; and
performing the modification of the interface elements comprises modifying the interface elements to include an interface element configured to activate a virtual agent to intervene the session based on determining that the user experiences a friction in the session according to the plurality of individual experience metric instances.

10. The system of claim 9, wherein determining that the user has a poor experience in the session according to the plurality of individual experience metric instances comprises determining that the plurality of individual experience metric instances has a decreasing trend.

11. The system of claim 9, wherein each of the plurality of individual experience metric instances is calculated each time when the user interacts with the online platform.

12. The system of claim 8, wherein computing the individual experience metric for a user comprises computing a proportion of pairwise successive actions of a user that show increase in proxy ratings associated with the user.

13. The system of claim 8, wherein computing the first transition experience metric for the first pair of successive actions comprises computing a proportion of instances of the first pair of successive actions that show increase in proxy ratings associated with the users.

14. The system of claim 8, wherein accessing the interaction data comprises accessing the interaction data of the plurality of users after sessions of the plurality of users browsing the online platform have completed, and wherein the operations further comprise:
clustering the plurality of users based on a pattern of the individual experience metrics associated with respective users; and
presenting the individual experience metrics and the transition experience metrics based on clustering of the plurality of users.

15. A non-transitory computer-readable medium having program code that is stored thereon, the program code executable by one or more processing devices for performing operations comprising:
operating an environment evaluation system for working with a host system that is configured to host an online platform and perform a modification of interface elements of the online platform based on interface experience metrics computed from interaction data; and
performing, with one or more processing devices of the environment evaluation system, operations comprising:
accessing interaction data recording interactions by a plurality of users with the online platform;
a step for computing interface experience metrics for the plurality of users based on the interaction data, comprising:
computing a first transition experience metric for a first pair of successive actions in a sequence of actions in the interactions by a user with the online platform;
computing a second transition experience metric for a second pair of successive actions in the sequence of actions in the interactions by the user with the online platform;
a step for identifying, from the plurality of users, a set of users who have a poor experience with the online platform, comprising:
identifying, from at least the first pair of successive actions and the second pair of successive actions, a pair of successive actions performed by the user that has a transition experience metric below a second threshold value; and
updating the host system with the interface experience metrics comprising the first transition experience metric and the second transition experience metric for use by the host system to perform the modification of the interface elements to improve the interface experience metrics, performing the modification comprising transmitting modified content of the interface elements of the online platform to the set of users to improve the interface experience metrics of the set of users.

16. The non-transitory computer-readable medium of claim 15, wherein the step for computing the interface experience metric comprises:
a step for computing an individual experience metric for each user of the plurality of users; and
a step for computing a transition experience metric for each pair of successive actions in the interactions by the plurality of users with the online platform.

17. The non-transitory computer-readable medium of claim 16, wherein:
accessing the interaction data comprises accessing the interaction data of a user during a session of the user browsing the online platform;
the step for computing the individual experience metric for the user comprises computing a sequence of values for the individual experience metric of the user during the session; and
performing the modification of the interface elements comprises modifying the interface elements to include an interface element configured to activate a virtual agent to intervene the session based on the sequence of values of the individual experience metric.

18. The non-transitory computer-readable medium of claim 17, wherein modifying the interface elements based on the sequence of values of the individual experience metric comprises modifying an arrangement of the interface elements based on determining that the sequence of values of the individual experience metric has a decreasing trend.

19. The non-transitory computer-readable medium of claim 17, wherein the sequence of values of the individual experience metric is generated by calculating the individual experience metric each time when the user interacts with the online platform.

20. The non-transitory computer-readable medium of claim 15, wherein accessing the interaction data comprises accessing the interaction data of the plurality of users after sessions of the plurality of users browsing the online platform have completed, and wherein the operations further comprise:
clustering the plurality of users based on a pattern of the interface experience metrics associated with respective users; and
presenting the interface experience metrics based on clustering of the plurality of users.
